(19) United States
(12) Patent Application Publication
(10) Pub. No.: US 2012/0001397 A1
(43) Pub. Date: Jan. 5, 2012

(54) EXTRUDED TORQUE RODS

(75) Inventor: Ronald J. McLaughlin, Maumee, OH (US)

(73) Assignee: The Pullman Company, Milan, OH (US)

(21) Appl. No.: 12/828,517

(22) Filed: Jul. 1, 2010

(51) Int. Cl. B60G 9/00; B23K 20/12

(52) U.S. Cl. 280/124.1; 228/112.1

(57) ABSTRACT

A light weight torque rod includes a first end joint assembly, a second end joint assembly and a connecting rod. The connecting rod is a non-ferrous material connecting rod that is produced by an extrusion process. The connecting rod is welded to the first and second end joint assemblies using a welding process which produces a full face weld. The first and second end joint assemblies can include an eye which is manufactured from an extrusion process and the eye can also be manufactured from a non-ferrous material.

### FIELD

The present disclosure relates to vehicle suspension rods. More particularly, the present disclosure relates to light weight vehicle suspension rods which are cast or otherwise formed from light weight materials. The individual components, once produced, are joined using a lateral friction or inertia welding process.

### BACKGROUND

Vehicle suspension rods and in particular torque rod assemblies are used in the transportation industry to stabilize vehicle axles relative to a vehicle frame. A typical torque rod assembly comprises a rod or a link with connectors attached at each end. The designs for the connectors vary, but prior art designs have included ball studs, metal tubes and straddle bars. In a typical application, one end of the torque rod assembly is connected to a vehicle frame or other supporting member and the other end is connected to an axle or other component of the vehicle. The torque rod connectors usually permit rotation or pivoting of the connecting rod or link in several planes and these connectors are often isolated from shock with elastomeric bushings. The torque rod assemblies have been mounted parallel to, at an angle or perpendicular to the vehicle axle. There are some designs where the torque rod assemblies are mounted in a transverse or “V” pattern relative to the vehicle axle. In all of the above designs, the torque rod assemblies prevent the axles or other components from rotating about their own axis, from moving for-and-aft, and from moving laterally.

Due to the severe loadings on torque rod assemblies, these assemblies have traditionally been manufactured from steel rods, steel tubing, forgings and castings. These components, once produced, are welded together using MIG, TIG or some other surface welding technique. The current manufacturing methods for these assemblies are costly with a large portion of the costs being associated with the machining of the raw forgings or castings in order to permit the assembly of the bushings and the connectors.

Steel stampings have been considered for this application. However, the end configurations required to support the torque rod connectors have proven to be difficult to form.

Recently, attempts have been made to manufacture torque rod assemblies using composite materials and molded polymers for the connecting rod or link. These types of torque rod assemblies have a variety of disadvantages. For example, the materials are generally not strong enough to withstand the variety of loadings to which they are subjected. In some cases, the material is not rigid enough to provide the stability required on the vehicle. Some materials are subject to impact damage, as one would expect from a gravel road. Some of the molded torque rod assemblies which have adequate strength are too bulky to fit the particular application. Finally, some molded torque rod assemblies are simply too expensive.

More recently, torque rod assemblies have been designed using a stamped steel metal reinforcement plate having a pair of flange reinforced bores located at each end of the plate. The reinforcement plate is encased within a polymer shell with the shell being of a different material than the reinforcement plate. The encasing of the reinforcement plate within the polymer shell eliminates the need for machining the ends of the torque rods as well as any need to weld the torque rods. While these torque rod assemblies have proven to be useful in some applications, due to the stamped metal plate only being a reinforcement plate, the maximum loading for these hybrid torque rod assemblies is limited.

### SUMMARY

This section provides a general summary of the disclosure, and is not a comprehensive disclosure of its full scope or all of its features.

The present disclosure is directed to an extruded or otherwise formed vehicle suspension rod. The disclosure allows the use of lighter, less expensive materials such as aluminum. The individual components are connected together using inexpensive full face welds. This provides the strength and fatigue resistance which approaches the base material.

The present disclosure uses eyes that are extruded from billets of a light weight material such as aluminum. The eyes are extruded in a profile that typically require minimal additional manufacturing operations and are sawed or otherwise cut into appropriate lengths. While aluminum has been mentioned as the light weight material, other materials including, but not limited to, titanium and magnesium could also be used. The connecting rod is typically a slender rod of an infinitely variable cross-section including, but not limited to, a hollow circular cylinder, a hollow square or rectangle, a solid cross, a solid I-beam or a solid angle. The connecting rod is also made from a light weight material, including but not limited to, aluminum, titanium and magnesium. The material for the connecting rod does not have to be the same material as the eye. In certain applications, the connecting rod can be more complicated and include a center pivot bearing, an irregular lateral shape or other designs that need only a flat section where the eyes are joined. The eyes are joined to the connecting rod using a friction welding process such as a lateral friction or inertia welding process. The welding process can be linear or rotary as long as a full face weld is provided. The appropriate connecting device is inserted into the eye either before or after the welding.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a torque rod in accordance with the present disclosure;

FIG. 2 is a cross-sectional view of the connecting rod illustrated in FIG. 1;

FIG. 3 is a cross-sectional view of one of the end joint assemblies illustrated in FIG. 1;

FIG. 4 is a cross-sectional view of a connecting rod in accordance with another embodiment of the present disclosure;

FIG. 5 is a cross-sectional view of a connecting rod in accordance with another embodiment of the present disclosure;

FIG. 6 is a cross-sectional view of a connecting rod in accordance with another embodiment of the present disclosure;

FIG. 7 is a cross-sectional view of a connecting rod in accordance with another embodiment of the present disclosure;

FIG. 8 is a perspective view of a torque rod in accordance with another embodiment of the present disclosure;

FIG. 9 is a cross-sectional view of one of the end joint assemblies illustrated in FIG. 8;

FIG. 10 is a cross-sectional view of the other of the end joint assembly illustrated in FIG. 8;

FIG. 11 is a perspective view of a torque rod in accordance with another embodiment of the present disclosure;

FIG. 12 is a cross-sectional view of the center connector of the torque rod assembly illustrated in FIG. 11; and

FIG. 13 is a flow chart illustrating the manufacturing process for producing the torque rods of this disclosure.

Corresponding reference numerals indicate corresponding parts throughout the several views of the drawings.

### DETAILED DESCRIPTION

Example embodiments will now be described more fully with reference to the accompanying drawings.

Vehicle suspension rods can include torque rods, radius rods, pivot arms, V-rods, A-frames, triangles, track bars, panhard rods, trailing links and control arm links. While the present disclosure is being described using a torque rod as an example, the present disclosure is not limited to torque rods and the present disclosure can be applicable to any of the above vehicle suspension rods or any other vehicle suspension rod.

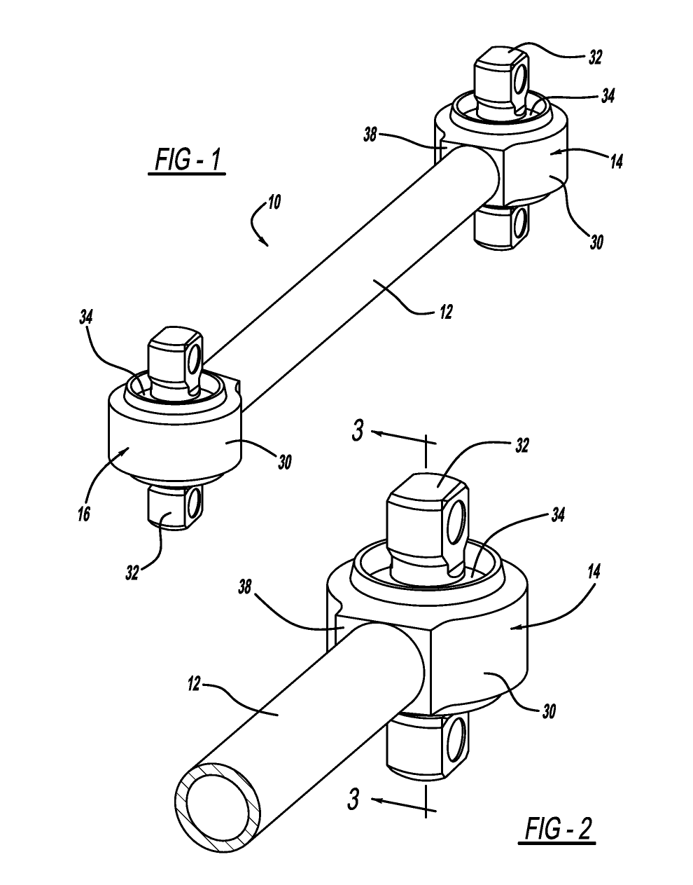

Referring now to the drawings in which like reference numerals designate like or corresponding parts throughout several views, there is shown in FIG. 1 a torque rod assembly in accordance with the present invention and which is designated generally by the reference numeral 10. Torque rod assembly 10 comprises a connecting rod 12, a first end joint assembly 14 and a second end joint assembly 16.

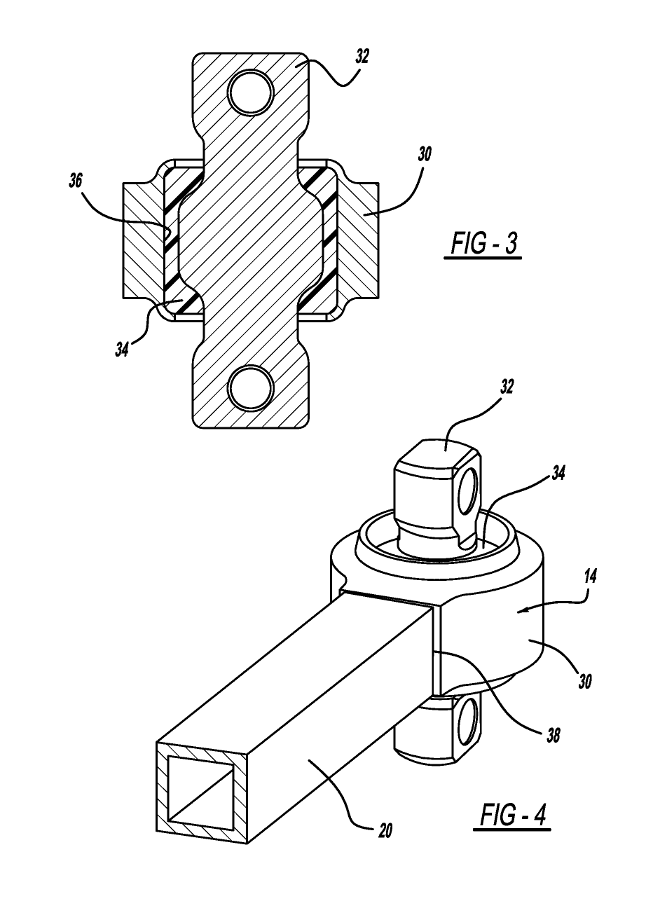

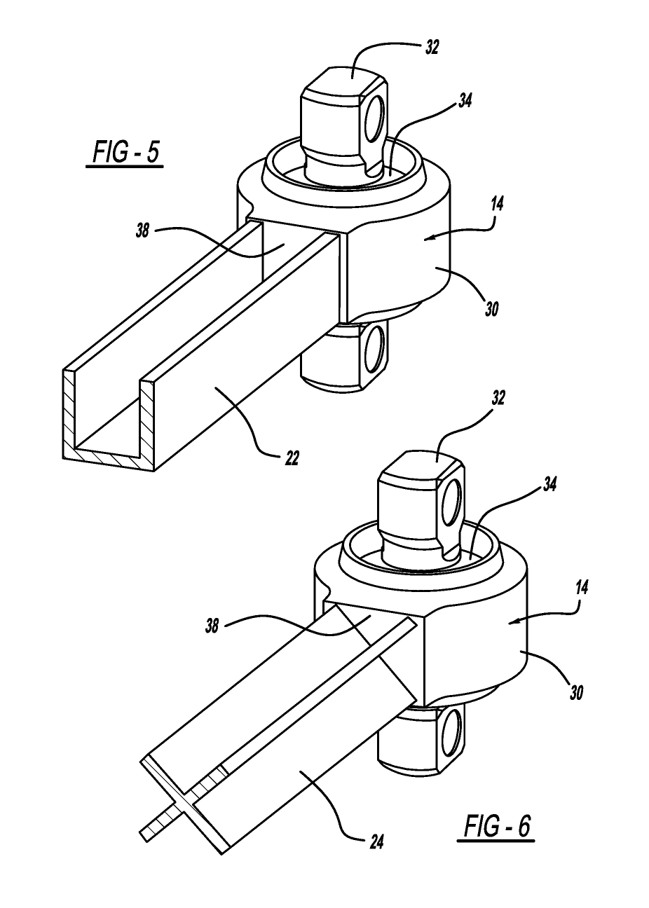

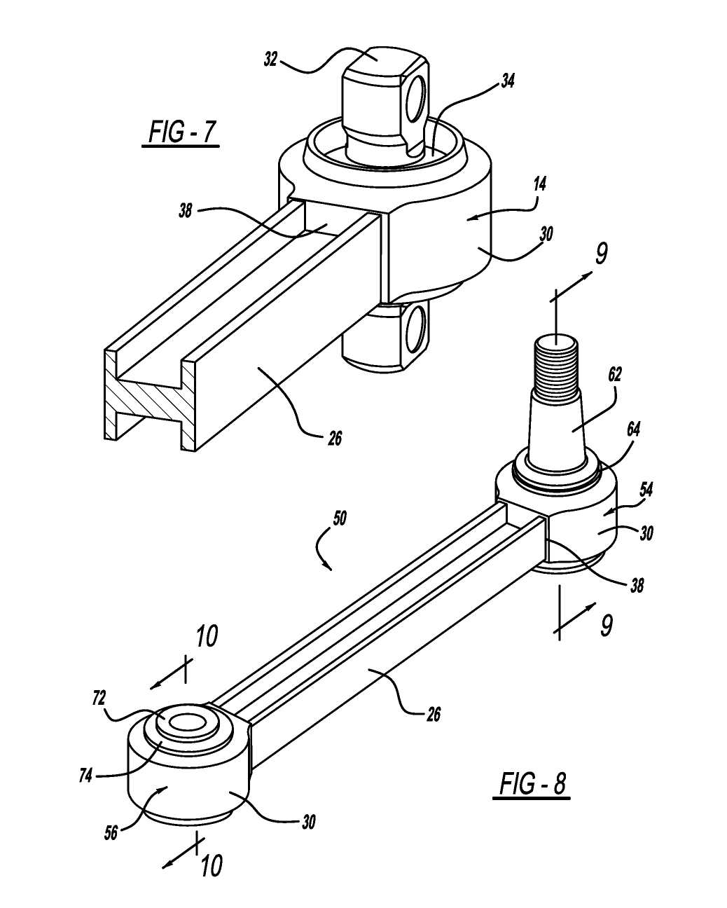

Referring now to FIGS. 1-3, connecting rod 12 is a circular cylindrical tubular rod which extends between first and second end joint assemblies 14 and 16. Connecting rod 12 is formed from a light weight material by an extrusion process. The material for connecting rod 12 includes, but is not limited to, aluminum, magnesium and titanium. Connecting rod 12 is attached to each of the first and second end joint assemblies 14 and 16 by a full face weld using a lateral friction process or an inertia welding process. While connecting rod 12 is illustrated as a circular cylindrical tubular member, it is within the scope of the present disclosure to have other cylindrical tubular shapes for connecting rod 12 such as a rectangular cylindrical shape illustrated in FIG. 4 for an extruded connecting rod 20, an oval cylindrical tubular shape or any other cylindrical tubular shape. The shape for the extruded light weight connecting rod is not limited to a cylindrical tubular shape. Any extruded cross-section that meets the load requirements for the application can be used. These shapes include, but are not limited to, a U-shaped cross-section connecting rod 22 illustrated in FIG. 5, an X-shape cross-section connecting rod 24 illustrated in FIG. 6 and an I-shaped cross-section connecting rod 26 as illustrated in FIG. 7.

End joint assembly 14 is the same as end joint assembly 16 so only end joint assembly 14 will be described. It is to be understood that the description of end joint assembly 14 applies to end joint assembly 16 also. While end joint assembly 16 is illustrated as being the same as end joint assembly 14, it is within the scope of the present disclosure that end joint assembly 16 can be different than end joint assembly 14. End joint assembly 14 includes an eye 30, a bar pin 32 and an elastomeric bushing 34 disposed between eye 30 and bar pin 32.

Eye 30 is an extruded component that defines an internal bore 36. Bar pin 32 and elastomeric bushing 34 are disposed within internal bore 36. Eye 30 defines a flat face 38 which mates to the end face of connecting rod 12, 20, 22, 24 or 26. The interface between the end of connecting rod 12, 20, 22, 24 or 26 and flat face 38 of eye 30 provide for a full face weld using a friction welding process such as a lateral friction process or an inertia welding process. The full face weld means that the entire cross-sectional surface of connecting rod 12, 20, 22, 24 or 26 is welded to flat face 38 of eye 30. This is different than the prior art MIG or TIG welding that only welds the outer surface of the cross-section of the connecting rod. The material for connecting rod 12, 20, 22, 24 or 26 does not have to be the same as the material for eye 30 and each eye 30 can be made from a different material.

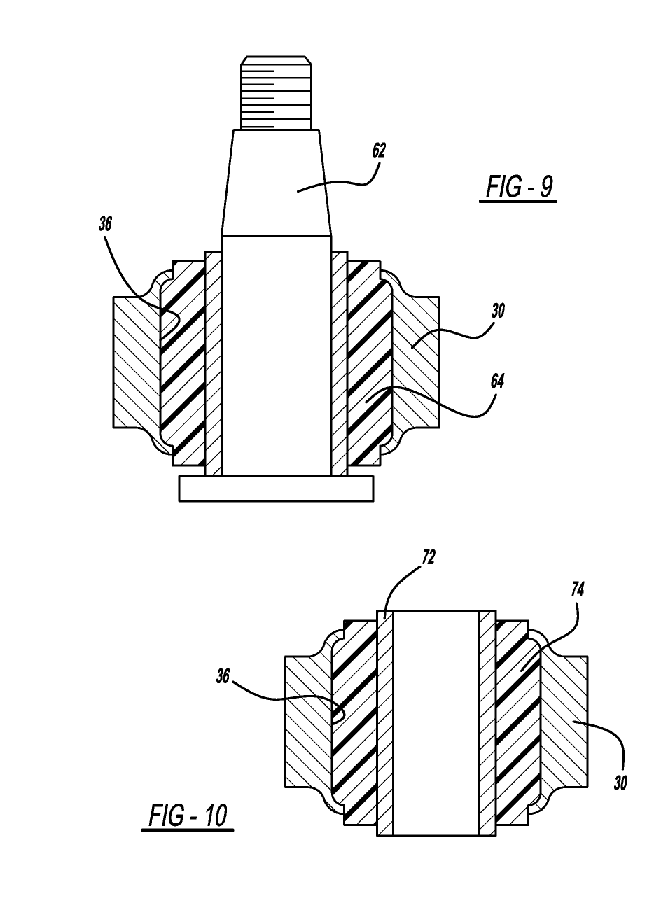

Referring now to FIGS. 8-10, a torque rod assembly 50 in accordance with another embodiment of the present disclosure is illustrated. Torque rod assembly 50 comprises connecting rod 26, a first end joint assembly 54 and a second end joint assembly 56. While torque rod assembly 50 is illustrated with connecting rod 26, it is within the scope of the present disclosure to use any of the connecting rods described above for torque rod assembly 50.

End joint assembly 54 comprises eye 30, a tapered stud 62 and an elastomeric bushing 64 disposed between eye 30 and tapered stud 62. Eye 30 is an extruded component that defines internal bore 36. Tapered stud 62 and elastomeric bushing 64 are disposed within internal bore 36. Eye 30 defines flat face 38 which mates to the end face of connecting rod 26. The interface between the end of connecting rod 26 and flat face 38 of eye 30 provide for a full face weld using a friction welding process such as a lateral friction process or an inertia welding process. The full face weld means that the entire cross-sectional surface of connecting rod 26 is welded to flat face 38 of eye 30. This is different than the prior art MIG or TIG welding that only welds the outer surface of the cross-section of the connecting rod. The material for connecting rod 26 does not have to be the same as the material for eye 30 and each eye 30 can be made from a different material.

End joint assembly 56 comprises eye 30, a tubular connector 72 and an elastomeric bushing 74 disposed between eye 30 and tubular connector 72. Eye 30 is an extruded component that defines internal bore 36. Tubular connector 72 and elastomeric bushing 74 are disposed within internal bore 36. Eye 30 defines flat face 38 which mates to the end face of connecting rod 26. The interface between the end of connecting rod 26 and flat face 38 of eye 30 provide for a full face weld using a friction welding process such as a lateral friction process or an inertia welding process. The full face weld means that the entire cross-sectional surface of connecting rod 26 is welded to flat face 38 of eye 30. This is different than the prior art MIG or TIG welding that only welds the outer surface of the cross-section of the connecting rod. The material for connecting rod 26 does not have to be the same as the material for eye 30 and each eye 30 can be made from a different material.

While torque rod assembly 50 is illustrated with end joint assemblies 54 and 56, it is within the scope of the present invention to utilize any of end joint assemblies 14, 16, 54 and 56 or any other end joint assembly known in the art in any of the torque rod assemblies described in this disclosure. It is also to be understood that for any individual torque rod assembly, the end joint assemblies do not have to be the same end joint assembly at each end of the torque rod assembly.

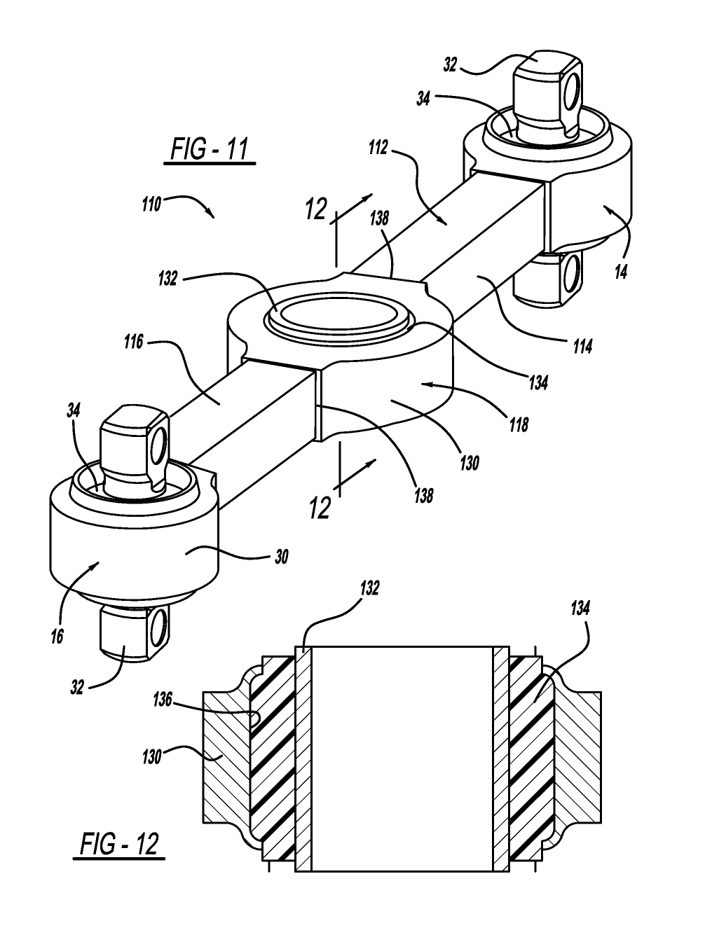

Referring now to FIGS. 11-12, a torque rod assembly 110 in accordance with another embodiment of the present disclosure is illustrated. Torque rod assembly 110 comprises a connecting rod assembly 112, first end joint assembly 14 and second end joint assembly 16. End joint assemblies 14 and 16 are detailed above and the description will not be repeated here.

Connecting rod assembly 112 comprises a first connecting rod 114, a second connecting rod 116 and a center joint assembly 118. First and second connecting rods 114 and 116 are rectangular cylindrical tubular components which are friction welded to first and second end joint assemblies 14 and 16, respectively, in the same manner as described above for the welding of connecting rod 12. In addition, first and second connecting rods 114 and 116 are friction welded to center joint assembly 118 in the same manner as described above for the welding of connecting rod 12. While connecting rods 114 and 116 are illustrated as rectangular cylindrical tubular components, it is within the scope of the present disclosure to use any of the cross-sections discussed in this disclosure for connecting rods 114 and 116.

Center joint assembly 118 comprises an eye 130, a tubular connector 132 and an elastomeric bushing 134 disposed between eye 130 and tubular connector 132. While center joint assembly 118 is illustrated using tubular connector 132, it is within the scope of the present disclosure to utilize bar pin 32, tapered stud 62 or any other connector known in the art for center joint assembly 118.

Eye 130 is an extruded component that defines an internal bore 136. Tubular connector 132 and elastomeric bushing 134 are disposed within internal bore 136. Eye 130 defines a pair of flat faces 138 each of which mates to one of the end faces of connecting rods 114 and 116. The interface between the end of connecting rods 114 and 116 and flat faces 138 of eye 130 provide for a full face weld using a friction welding process such as a lateral friction process or an inertial welding process. The full face weld means that the entire cross-section of connecting rods 114 and 116 are welded to their respective flat face 138 of eye 130. This is different than the prior art MIG or TIG welding that only welds the outer surface of the cross-section of the connecting rod. Eye 130, each eye 30 and connecting rods 114 and 116 can all be manufactured from different material.

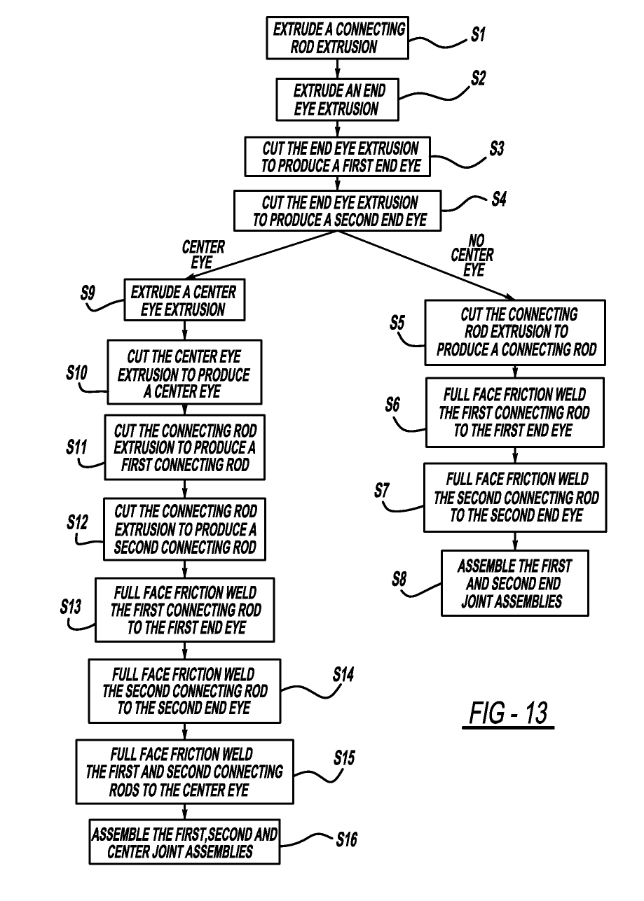

Referring now to FIG. 13, the process for making a torque rod assembly in accordance with the present disclosure is described. At step S1, a connecting rod extrusion of the light weight material is manufactured. At step S2, an end eye extrusion of the light weight material is manufactured. At steps S3 and S4, the end eye extrusion is cut to produce a first and a second end eye. Optionally, the step of forming an end eye extrusion could form a single complete single piece end eye extrusion, two of which would be required for the torque rod assembly.

If no center joint assembly is present, the process proceeds through steps S5-S8. At step S5, a connecting rod is formed by cutting the connecting rod extrusion. Optionally, the connecting rod extrusion process could produce the finished length for the connecting rod. In steps S6-S7, the connecting rod is full face friction welded to the first and second end eyes. In step S8, the end joint assemblies are assembled.

If the center joint assembly is present, the process proceeds from step S4 to steps S9-S16. In step S9, a center eye extrusion is manufactured. In step S10 a center eye is formed by cutting the center eye extrusion. Optionally, the center eye extrusion process could produce a finished center eye. In steps S11 and S12, the connecting rod extrusion is cut to produce a first and second connecting rod. Optionally, the connecting rod extrusion process could produce the finished lengths for the first and second connecting rods. Also, separate extrusion processes for the first and second connecting rods could replace the single extrusion process if the first and second connecting rods do not have the same cross-section. In steps S13 and S14, the first and second connecting rods are full face friction welded to the first and second end eyes, respectively. In step S15 the first and second connecting rods are full face friction welded to the center eye. In step S16, the first, second and central joint assemblies are assembled.

The light weight torsion bar assemblies described above provide equivalent strength and fatigue resistance to the heavier designs because of the full face friction welding of the components. In addition, the extrusion process for the eyes eliminates most, if not all, of the machining and other manufacturing operations on the eyes.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A torsion bar comprising:
a first joint assembly;
a second joint assembly;
a connecting rod disposed between said first joint assembly and said second joint assembly;
a first full face weld connecting said first joint assembly to said connecting rod; and
a second full face weld connecting said second joint assembly to said connecting rod.

2. The torsion bar according to claim 1, wherein said connecting rod is a non-ferrous metal material.

3. The torsion bar according to claim 2, wherein said connecting rod is a tubular component.

4. The torsion bar according to claim 3, wherein said connecting rod is a circular cylindrical tubular component.

5. The torsion bar according to claim 3, wherein said connecting rod is a rectangular cylindrical tubular component.

6. The torsion bar according to claim 2, wherein said connecting rod has a U-shaped cross-section.

7. The torsion bar according to claim 2, wherein said connecting rod has an X-shaped cross-section.

8. The torsion bar according to claim 2, wherein said connecting rod has an I-shaped cross-section.

9. The torsion bar according to claim 1, wherein said connecting rod is an extruded component.

10. The torsion bar according to claim 1, wherein said connecting rod is a ferrous metal material and the first and second joint assemblies include a non-ferrous metal component welded to said connecting rod.

11. The torsion bar according to claim 1, wherein the first full face weld attaches a flat surface on said first joint assembly to a flat surface on said connecting rod.

12. A method of producing a torsion bar, the method comprising:
providing a first end joint;
providing a second end joint;
providing a connecting rod;
welding said first end joint to said connecting rod using a first friction welding process to produce a first full face weld; and
welding said second end joint to said connecting rod using a second friction welding process to produce a second full face weld.

13. The method of producing a torsion bar according to claim 12, wherein said step of providing the connecting rod includes providing a non-ferrous metal material for said connecting rod.

14. The method of producing a torsion bar according to claim 13, wherein said step of providing the connecting rod includes an extrusion process to produce said connecting rod.

15. The method of producing a torsion bar according to claim 14, wherein the step of providing a first end joint includes extruding an eye for said first end joint.

16. The method of producing a torsion bar according to claim 15, wherein said eye is manufactured from a non-ferrous material.

17. The method of producing a torsion bar according to claim 12, wherein said first friction welding process is a lateral friction welding process.

18. The method of producing a torsion bar according to claim 12, wherein said first friction welding process is an inertia welding process.

19. The method of producing a torsion bar according to claim 12, wherein the step of welding said first end joint to said connecting rod includes engaging a flat surface on said first end joint with a flat surface on said connecting rod.

20. The method of producing a torsion bar according to claim 12, wherein:
said step of providing a connecting rod provides a first and a second connecting rod;
said step of welding said first end joint to said connecting rod welds said first connecting rod to said first end joint;
said step of welding said second end joint to said connecting rod welds said second connecting rod to said second end joint; the method further comprising:
providing a center joint;
welding said center joint to said first connecting rod using a third friction welding process to produce a third full face weld; and
welding said center joint to said second connecting rod using a fourth friction welding process to produce a further face weld.
